(19) United States
(12) Patent Application Publication
(10) Pub. No.: US 2024/0410483 A1
(43) Pub. Date: Dec. 12, 2024

(54) RUPTURE DISK WITH CURLED LINE OF WEAKNESS

(71) Applicant: BS & B INNOVATIONS LIMITED, Limerick (IE)

(72) Inventor: Geoffrey Brazier, Woodbury, MN (US)

(21) Appl. No.: 18/731,807

(22) Filed: Jun. 3, 2024

Related U.S. Application Data
(60) Provisional application No. 63/505,957, filed on Jun. 2, 2023.

(51) Int. Cl. F16K 17/16

(52) U.S. Cl. CPC F16K 17/1606

(57) ABSTRACT

The present disclosure relates to a rupture disk suitable for use with a sealed and/or pressurized system.

### CROSS-REFERENCE TO RELATED APPLICATIONS

The disclosure claims the benefits of priority to U.S. Provisional Application No. 63/505,957, filed Jun. 2, 2023, which is incorporated herein by reference in its entirety.

### FIELD

The present disclosure relates to a rupture disk suitable for use with a sealed and/or pressurized system.

### BACKGROUND

There are many types of systems that process, transport, store, or utilize fluid, which may be sealed in a container. The fluid may be a liquid, gas, or a mixture of a liquid and gas. The fluid may also include solid components. For example, a system may contain a gas that includes solid particulates. As another example, a system may transport solid components in a fluid environment. A sealed container may be pressurized. Alternatively, the sealed container may contain a process (e.g., chemical) that may become pressurized. To ensure the safety of these types of sealed systems, each such system typically includes a safety device designed to prevent (or at least provide an alarm indication during) the over-pressurization of the system. In an emergency situation, pressure inside the sealed container acts on the safety device to create an opening to release fluid from the system. Outside of creating an opening, the safety device may simply provide an alert warning, indicating that a dangerous over-pressure situation is occurring or may be about to occur. In devices that actually rupture, or otherwise open, venting fluid to the environment or a safety reservoir through the opening reduces the pressure in the system and prevents another portion of the system from failing due to the high pressure of the fluid.

A rupture disk is one commonly used example of a safety device. A rupture disk can be attached to a sealed system to expose a certain portion of the rupture disk to the fluid in the system. A portion of the rupture disk exposed to the fluid is configured to rupture or tear when the fluid in the container reaches a predetermined pressure. The tearing or rupture of the disk creates an opening through which the pressurized fluid flows to reduce the pressure in the system. A rupture disk may include a scored line of weakness designed to ensure opening at a particular location, in response to a particular pressure, and in a particular “burst pattern.” A scored line of weakness may be provided by way of a laser, mechanical displacement or thinning, or chemical etching process that involves removing material from a portion of the disk. A line of weakness also may be created through a partial shearing process, as described in co-owned U.S. Pat. No. 5,934,308, the entire contents of which are hereby incorporated by reference as if set forth herein. Additional disclosure of a rupture disk having a line of weakness is set forth in co-owned International Application No. PCT/US2018/055486, published as WO/2019/075255, the entire contents of which are hereby incorporated by reference as if set forth herein.

In the field of “reverse-buckling” rupture disk pressure relief devices, a concave/convex-shaped structure has been used as a means of providing a reliable and reproducible pressure responsive device. Known reverse-buckling devices are designed such that when the convex side of the structure is exposed to a predetermined overpressure force, the structure buckles and inverts, causing the convex side to collapse into a concave shape. The rupture disk may be designed not only to invert, but also to open by means of a line of weakness.

In a known reverse-buckling, circular-scored rupture disk, a line of weakness is provided in a single plane, as illustrated in FIG. 1. The known line of weakness may be located at various elevations on a dome portion of the disk. Alternatively, the known line of weakness may be located on or near a transition between a dome portion and flat/flange portion of the disk. A known line of weakness may be imparted by mechanical means and hard tooling. Employing such means, the position of a line of weakness is limited to a single plane to avoid overly complicated and very expensive tooling. This plane maybe tilted slightly but is usually parallel to the flat or edge of the disk. Circular score lines are commonly used, as they provide a well-defined opening area after activation of the rupture disk reverse-buckling structure.

As discussed above, a rupture disk may be configured to open or tear at a line of weakness in response to a particular pressure, often in a dynamic manner (e.g., a propagating tear). When a single-plane line of weakness is provided on a rupture disk, however, it has been observed that the line of weakness has a strong tendency to continue to tear along its plane-even beyond the endpoint(s) of the line of weakness. Such continued tear propagation may result in the central portion of the disk (known as a “petal”) being at risk to separate from the remainder of the disk, releasing the central portion as a fragment. Fragmentation of a rupture disk petal is undesirable because it may damage or create an unsafe condition for the enclosed system, its surrounding environment, and nearby users/operators. To address fragmentation, a known rupture disk employs a secondary downstream component—referred to as a “hinge”—which may be connected to the disk or held downstream in a holder device. The hinge may “catch” a petal and slow or arrest its movement, reducing the risk of fragmentation. One example of a circular-scored reverse-buckling rupture disk with a downstream secondary hinge is illustrated in FIG. 2. Further examples known in the art are marketed by BS&B Safety Systems under the names SKr, LPS, Sigma, and GCR. Examples of circular scored reverse-buckling disks having a secondary hinge located in a downstream holder member are marketed by BS&B Safety Systems under the names CSR and CSI.

Adding a secondary hinge component adds cost and additional steps to the manufacturing process. Adding a secondary hinge also may undesirably obstruct the flow characteristics of the system, resulting in a less efficient evacuation of fluid (gas or liquid) and/or pressure. Accordingly, there is a need for a rupture disk design to eliminate the need for a secondary hinge component, thereby resulting in material savings, improved sustainability, and/or improved flow characteristics. There also is a need to provide enhanced fragmentation control even when a secondary hinge component is used.

Typical solutions to provide fragmentation control without using a secondary hinge require limiting the disk to very restricted ranges of low burst pressures and small nominal sizes, such as nominal sizes ⅛-inch to 1-inch. Such designs also rely on features provided in the central dome (or central truncated conical structure), such as a “bubble” impact the bore of the downstream holder or piping system to absorb the tearing energy at the score line.

There is a need for a pressure response device that overcomes one or more deficiencies in the art and/or provides additional benefits.

### BRIEF DESCRIPTION OF THE DRAWINGS

Embodiments and various aspects of the present disclosure are illustrated in the following detailed description and the accompanying figures.

Various features shown in the figures are not drawn to scale.

FIG. 1 illustrates three perspective views of a reverse-buckling, circular-scored rupture disk having a line of weakness.

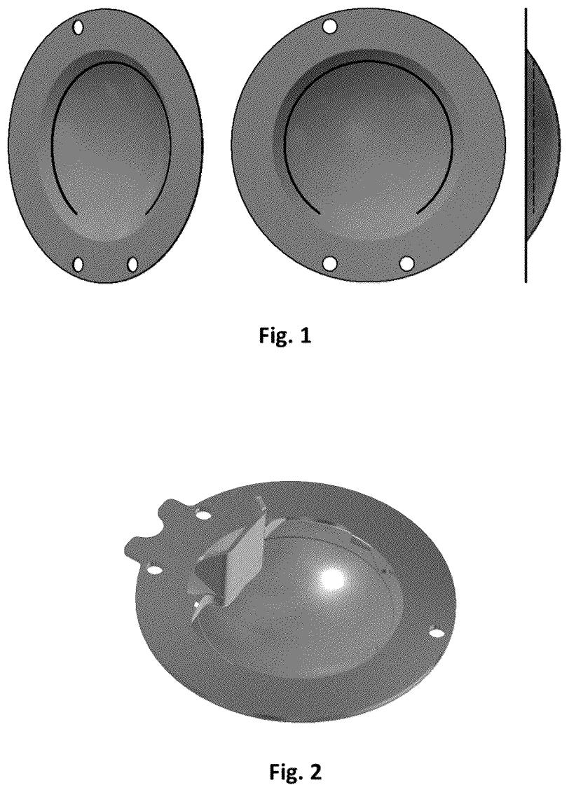

FIG. 2 illustrates a perspective view of a circular-scored reverse-buckling rupture disk with a downstream secondary hinge.

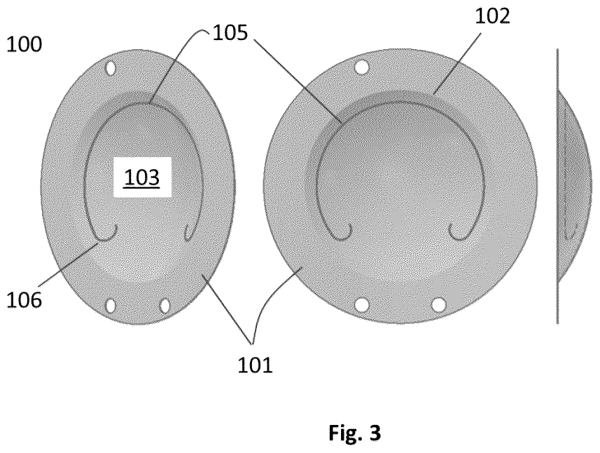

FIG. 3 illustrates three perspective views of a rupture disk having a line of weakness with a curl, according to an embodiment.

FIGS. 4A-4K illustrate further embodiments of a line of weakness, having different curl geometries, according to further embodiments.

FIGS. 5A and 5B illustrate a first rupture disk configuration having a metallic domed construction and a line of weakness in a single plane.

FIGS. 6A and 6B illustrate a second rupture disk configuration having a metallic domed construction and a curled line of weakness extending outside of a single plane.

FIGS. 7A and 7B illustrate exemplary curled lines of weakness according to further embodiments.

FIG. 8 illustrates a rupture disk having a curled score line, in conjunction with a generally planar secondary hinge.

### DESCRIPTION OF THE EMBODIMENTS

Reference will now be made in detail to the present exemplary embodiments, examples of which are illustrated in the accompanying drawings. Wherever possible, the same reference numbers will be used throughout the drawings to refer to the same or like parts. The drawing figures of this application are intended to provide a general understanding of the working elements of the underlying system. Accordingly, unless explicitly stated, the figures do not represent a literal depiction of proportional dimensions or the precise locations for the illustrated inter-related components.

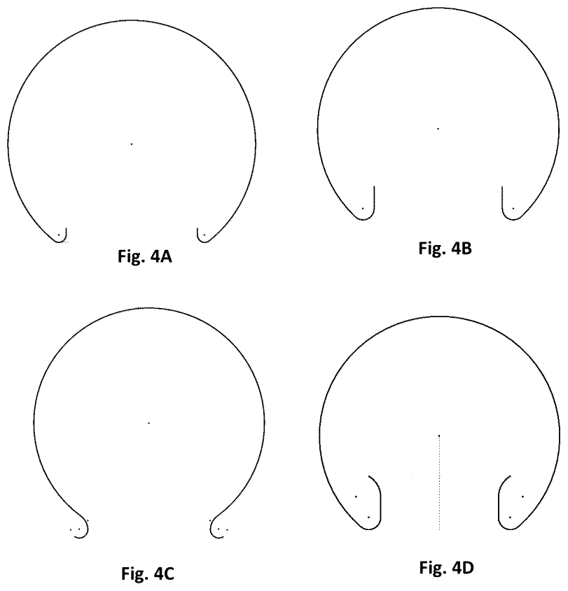

FIG. 3 illustrates an embodiment of the present disclosure. As illustrated, a rupture disk 100 has a flange 101 and a central portion 103 connected by a transition portion 102. As illustrated in FIG. 3, rupture disk 100 is a reverse-acting rupture disk, configured to be oriented with its convex surface toward the sealed interior of a container and/or a pressurized volume. The rupture disk 100 is configured to reverse in response to an overpressure condition in the sealed interior of the container and/or pressurized volume. In one embodiment, the rupture disk 100 may be configured to “burst” or tear open upon reversal, thereby allowing pressurized fluid to escape. In another embodiment, the rupture disk 100 may be configured to reverse without opening, thereby providing a visual indication of an overpressure condition (without releasing pressurized fluid from the container/volume).

As illustrated, rupture disk 100 is provided with a line of weakness 105. In FIG. 3, the line of weakness is generally circular, with the predominant central portion located in a first plane. However, the end portions 106 of the line of weakness form a curl shape, which causes the end portions 106 to extend outside of the first plane. The curl shape of the disclosure provides significant advantages. For example, the curl shape may stop the propagation of material tearing around a full circle, thereby causing the disk petal to be retained after the rupture disk has opened. Further, the curl shape may manage petal fragmentation over a wide range of burst pressures and nominal sizes, and may manage petal fragmentation without requiring the use of a downstream secondary hinge component. Thus, the illustrated disk provides improved performance and safety, with less material cost, and less flow obstruction.

It is contemplated that an embodiment utilizing a curl design may achieve the foregoing advantages by directing the opening path out of the plane of the opening and, thus, redirecting the forces away from the remaining material (e.g., the unscored/unweakened portion of the disk that forms the root of the petal) so that it will retain the central portion of the disk without the need for an additional component or hinge.

It is further contemplated that the curl design may be configured to influence petal shape after opening to enhance flow characteristics. For example, the curl illustrated in FIG. 3 may cause the disk petal to deform with a slender single petal after activation, which may conform to the bore of the downstream system, further minimizing obstruction of flow. An embodiment may produce desirable opening characteristics in both gas and liquid service, which may allow the rupture disk to be provided with a single certified flow resistance value (Kr) for both media, referred to as Krgl. Providing a single Krgl value offers significant advantages over known disk models, which require separate flow certifications for gas implementations (Krg) and liquid implementations (Krl), with Krl typically rated at comparatively higher levels of flow resistance.

Although FIG. 3 shows a single line of weakness, it is also contemplated that multiple lines of weakness may be provided on one or both of the concave and convex surfaces of a rupture disk.

The line of weakness 105 is illustrated as a continuous line of weakness. It is contemplated, however, that discontinuous, intermittent lines of weakness may alternatively be provided.

The present disclosure is not limited to circular lines of weakness. A line of weakness may, for example, follow an irregular path, eccentric to the rupture disk diameter. Alternatively, a line of weakness may form a complete or partial angular or polygonal shape (e.g., a triangular, square, rectangular, pentagonal, hexagonal, or other shape). In one embodiment, a line of weakness may include a combination of curved and straight or angular segments.

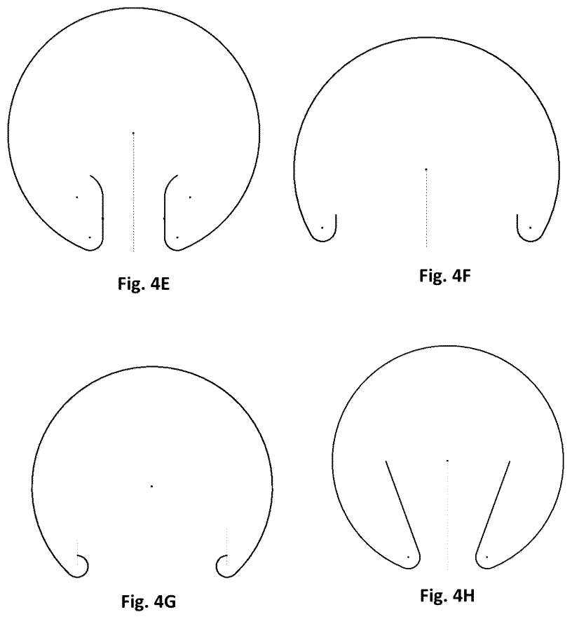

Further embodiments of a line of weakness, having different curl geometries, are illustrated in FIGS. 4A-4K. It is contemplated that changing the curl geometry may allow a user to refine the shape that the petal takes after opening, alter the shape of petal deformation after opening, or otherwise refine the opening characteristics of the rupture disk.

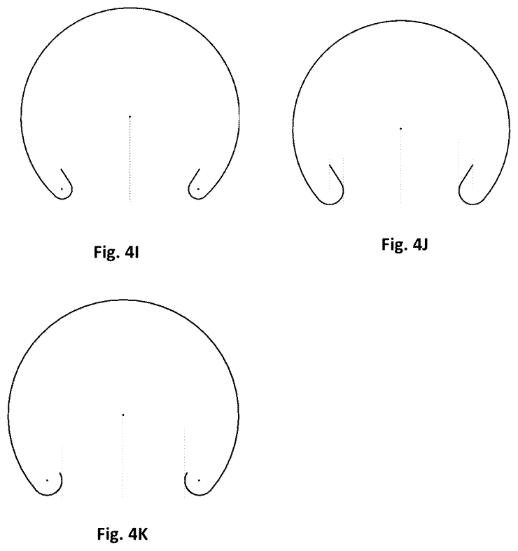

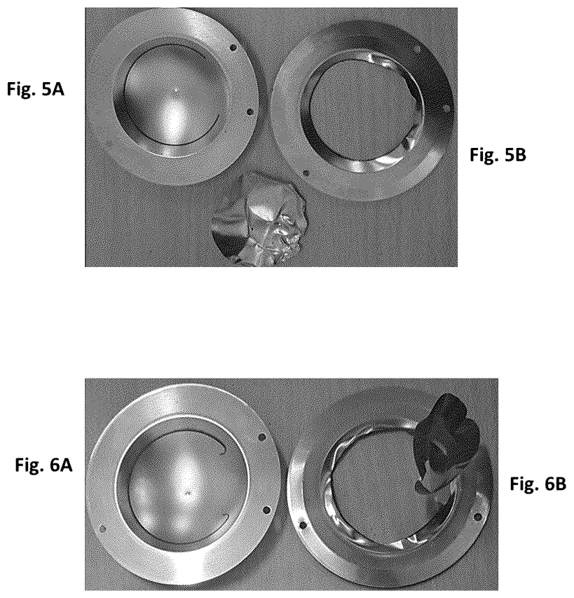

Testing of a reverse-buckling rupture disk having a line of weakness with a curl demonstrated significant improvements in performance. FIGS. 5A-5B illustrate a first rupture disk configuration having a metallic domed construction and a line of weakness in a single plane. FIGS. 6A-6B illustrate a second rupture disk configuration having a metallic domed construction similar to that of FIGS. 5A-5B, with both rated for 45 psig burst pressure, but with a curled line of weakness extending outside of a single plane. As illustrated in FIG. 5B, the conventional line of weakness resulted in complete fragmentation of a petal after activation. It is apparent from FIGS. 5A-5B that the dynamic opening of the central portion of the disk caused the single-plane line of weakness to continue to tear or separate along the plane and through the remaining material without the line of weakness. This caused the fragmentation of the central portion.

In contrast, a curled line of weakness caused the petal to be retained after activation as illustrated in FIG. 6B. Because the line of weakness was not contained in a single plane, the curl is able to redirect the forces away from the remaining material and thus prevent it from tearing or fragmenting.

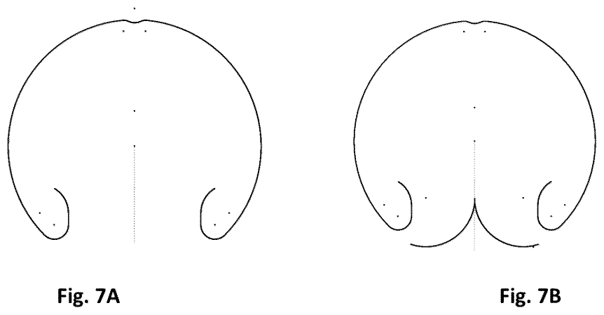

Turning to FIGS. 7A-7B, it is contemplated that the location of the disclosed line of weakness is not limited to the dome of the disk. For example, a line of weakness according to the disclosure may additionally or alternatively be located on the transition or flat circumferential portion of the disk. Further, a line of weakness according to the disclosure does not need to be a single line of weakness or even primarily circular in shape. Various other attributes can be added to the line of weakness, or even separate from the line of weakness, to enhance opening characteristics across a wide range of pressures and sizes. In one embodiment, an accessory may be provided to aid in the opening of accessory disk components such as plastic liners.

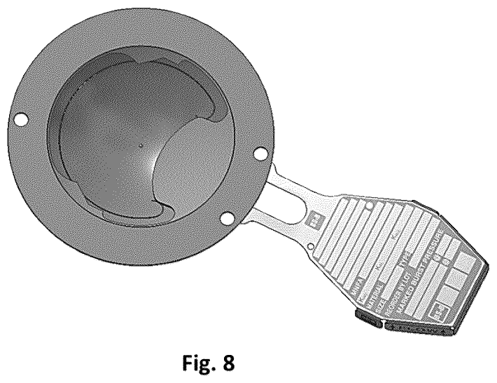

Although embodiments have been described in which a curled line of weakness may obviate the need for a downstream hinge component, it is further contemplated that a downstream hinge component or other secondary component may be provided to achieve further enhancements in performance. For example, adding a secondary component may allow for even greater pressure limits. For example, as illustrated in FIG. 8, a “curl” at the end of a score line may interact with a generally planar secondary hinge. The interaction between the score line curl and the secondary hinge may be designed to interrupt circular tear propagation at high burst pressures. Such a combination of design features may offer a high burst pressure liquid and gas compatible reverse buckling disk with improved mitigation of fragmentation.

It is contemplated that the disclosed score line features may be employed singly or in combination to achieve the desired application attributes to meet the requirements of specific rupture disk applications. For example, it is contemplated that a line-of-weakness curl may provide mitigation of fragmentation and improved consistency of opening pattern by directing good petal movement parallel to the bore and close to the wall of the holder device and piping system. At the same time, an irregular step positioned generally opposite to the disk hinge area may be configured to manipulate the stress pattern in the disk dome in order to manage the point of initiation of reversal or pattern of reversal. For example, a disk that initiates its reversal opposite the hinge member may exhibit improved performance, such as by way of a preferable opening pattern.

What is claimed is:

1. A rupture disk, comprising:
a flange portion; and
a reverse-buckling dome portion;
wherein the dome portion defines a line of weakness; and
wherein the line of weakness comprises a first end, a central line portion, and a second end; and
wherein at least one of the first end and second end extends outside of a plane defined by the central line portion.

2. The rupture disk of claim 1, wherein at least one of the first end and second end defines a curl.
